(19) United States
(12) Patent Application Publication
(10) Pub. No.: US 2009/0013055 A1
(43) Pub. Date: Jan. 8, 2009

(54) System and method of controlling terminal services availability remotely

(75) Inventors: David N. Hall, JR., Rancho Santa Margarita, CA (US); Tom Jefferson, Corona, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Toshiba America Information Systems, Inc.

(21) Appl. No.: 11/825,048

(22) Filed: Jul. 3, 2007

(51) Int. Cl. G06F 15/16

(52) U.S. Cl. 709/208

(57) ABSTRACT

According to one embodiment of the invention, a method comprises establishing network connectivity with a remotely located electronic device currently in a state that precludes access to the electronic device remotely. After such connections have been established, the state of the electronic device can be altered to allow access to the electronic device remotely.

### FIELD

Embodiments of the invention generally relate to a system and method for enabling and controlling the operations of the subscriber device remotely, including after waking up the subscriber device from any power-saving state including shutdown (S5) state.

### GENERAL BACKGROUND

Over the past decade, tremendous advances have been made in wireless communications, and thus, there has been an increased demand for wireless electronic devices. One reason for this increased demand is that wireless electronic devices are portable, which enables consumers to use the device in transit or when remotely located from one's home or office.

Due to their portability, however, wireless electronic devices are easily misplaced (forgotten but location known), lost or stolen. In fact, over one billion dollars (US) worth of laptop computers are stolen every year, and equally as important, thousands of normally productive work hours are wasted due to misplaced laptop computers.

This loss of productivity may be experienced over a large number of scenarios. For instance, a person may forget his or her laptops at home, and as a result, is unable to work productively that day. Worse yet, a person may lose his or her laptop during transit to a remote location, and as a result, has no means of working at that location. Hence, the ancillary costs for misplaced, lost or stolen laptop computers alone are enormous.

There are conventional services that enable remote access to a laptop computer. One service is referred to as “Terminal Services,” which is a component of the Microsoft® Windows® Operating System (OS), namely a Windows® service that runs on the computer and allows a user to communicate with the remote computer over a network connection in order to access applications or data therefrom. Currently, the Windows® XP® OS includes Terminal Services that, under certain conditions, provide a user remote access to the contents of his or her computer over the Internet.

However, Terminal Services currently cannot be established when the computer is in any power-saving state including a sleep state (S3/Standby, S4/Hibernate) or Shutdown (S5) state. Furthermore, even when the laptop computer is powered on and operational, Terminal Services are generally disabled and/or blocked by the Windows® firewall for security reasons. Thus, Terminal Services would fail to provide persons with an ability to gain access to contents of his or her computer at any time.

### BRIEF DESCRIPTION OF THE DRAWINGS

Features and advantages of embodiments of the invention will become apparent from the following detailed description in which:

FIG. 1 is an illustrative embodiment of a network implemented with a remote communication module.

FIG. 2A is an exemplary embodiment of the internal architecture of the subscriber device of FIG. 1 implemented with the remote communication module.

FIG. 2B is an illustrative embodiment of remote communication module of FIG. 2A.

FIG. 3 is an exemplary embodiment of the external architecture of the subscriber device of FIG. 1 implemented with the remote communication module.

FIG. 4 is illustrative embodiment of applications forming a backend service center of the network of FIG. 1.

FIG. 5 is an illustrative embodiment of the operations for a subscription service from registration to detection of an event necessitating a Remote Desktop Connection to the subscriber device.

FIGS. 6A-6D are illustrative embodiments of screen shots for different stages of the subscription process.

FIG. 7 is an exemplary embodiment of the remote communication module in operation with at least one application directed to Terminal Services and establishing a Remote Desktop connection.

FIG. 8 is an exemplary embodiment of an encapsulated XML message transmitted to the remote communication module over a SOAP XML interface.

FIG. 9 is an exemplary embodiment of the remote communication module in operation with setting an alarmed wake-up event.

FIG. 10 is an illustrative embodiment of the operations of the subscriber device and backend service center.

FIG. 11 is an illustrative embodiment of operations performed by the subscriber device to establish a Remote Desktop connection despite the subscriber device operating in any power-saving state including Shutdown (S5) state.

### DETAILED DESCRIPTION

Embodiments of the invention set forth in the following detailed description generally relate to a system, communication module and method for waking up a subscriber device from any power-saving state including shutdown (S5) state, and thereafter, remotely controlling the operations of a subscriber device after wake-up.

In general, one aspect of the invention is the development of a technique for remotely triggering a subscriber device to go from a secured state to a state in which Terminal Services (TS) are enabled. In the secured state, Terminal Services are disabled and a firewall is blocking all relevant communications. In the TS-enabled state, the firewall is still intact but open for Terminal Services, and an appropriate (routable) Internet connection is acquired and reported to the subscriber.

More specifically, according to one embodiment of the invention, a remote communication module 240 implemented within a subscriber device is capable of establishing network connectivity in response to waking the subscriber device from a Shutdown (S5). The “waking” of the subscriber device can be accomplished by either communications from a remote event or a local event. The remote communication module 240 may be implemented to support both local and remote events at the same time.

Herein, a “remote event” is an event that is initiated by a source remotely located from the subscriber device. For instance, the remote event may be wireless signaling, such as a phone call, wireless text message, or any RF signal that originates from the remote source. The remote event may also be wired signaling, such as remote booting in accordance with the Wake-On LAN standard.

A “local event” is an event that is prompted by components within the subscriber device itself. For instance, the local event may be a scheduled polling event prompted by an internal timer (e.g., RTC Wake Alarm set by programming the BIOS settings over Advanced Configuration and Power Interface “ACPI” or Serial Control Interface “SCI” interfaces).

In the following description, certain terminology is used to describe various features of one or more embodiments of the invention. For instance, a “subscriber device” is generally defined as any electronic device that is capable of establishing wired or wireless communications with a network in order to upload or download information from a resource (e.g., backend service center). Examples of a subscriber device include, but are not limited or restricted to a computer (e.g., laptop, tablet, handheld, desktop etc.), a personal digital assistant (PDA), a cellular telephone, an alphanumeric pager, a portable music player, a portable video or video game player, or the like.

The terms “application” and “module” generally refer to hardware, firmware, or software. “Software” is generally defined as one or more instructions that, when executed, cause the wireless electronic device to perform a specific function or operation. Stored in machine-readable medium, these instructions may be a series of instructions or may take the form of a program, a routine, an applet, or the like. Examples of a machine-readable medium, which is any medium that can store information, include an electronic circuit, a semiconductor memory device (non-volatile or volatile), an interconnect, a hard disk drive, and portable storage (e.g., flash drive, compact disc “CD”, digital versatile disk “DVD”, etc.).

A “message” is information that is arranged in a predetermined format for transmission over an interconnect, namely a wired or wireless pathway.

### I. Exemplary System Architecture

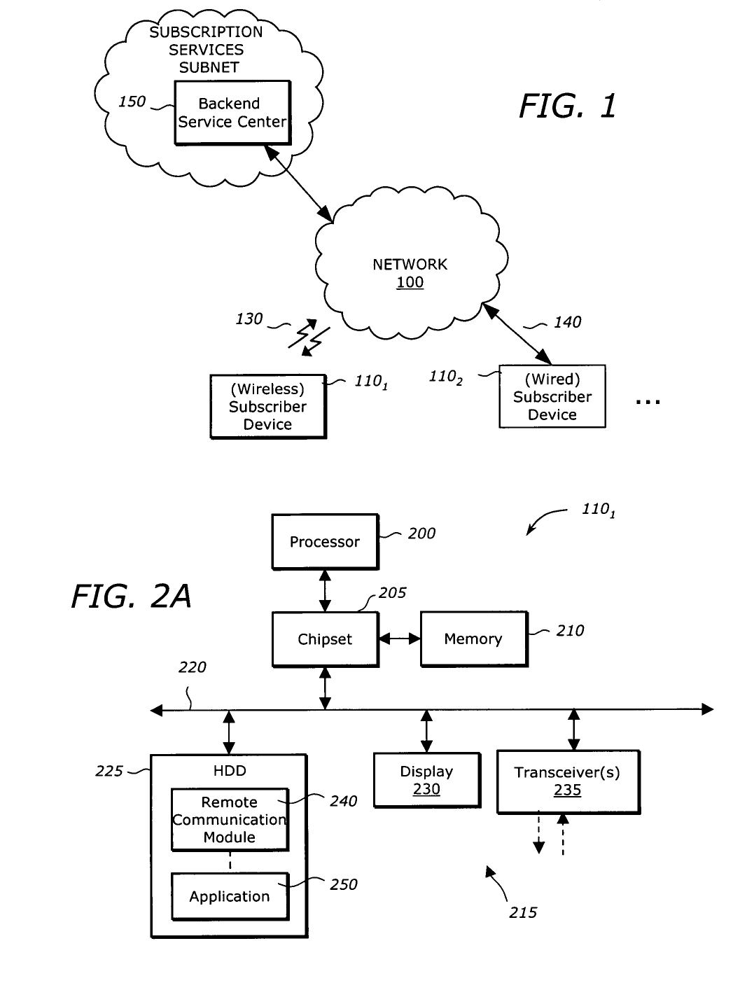

Referring to FIG. 1, an illustrative embodiment of a network 100 implemented with one or more subscriber devices featuring a remote communication module (described below) is shown. According to one embodiment of the invention, network 100 is a public network that provides connectivity between a plurality of subscriber devices 110₁-110_{N} (N≧1) and a backend service center 150. Examples of a “public network” include a wide area network such as the Internet. Of course, it is contemplated that network 100 may be a private network (e.g., local area network) or a combination of private and public networks.

As shown, for this illustrative embodiment, subscriber device 110₁ is a wireless electronic device that is capable of establishing wireless communications with network 100 through a wireless interconnect 130. These wireless communications, namely the exchange of electromagnetic waves that carry information such as radio-frequency (RF) signals or cellular signals for example, enable subscriber device 110₁ to communicate with backend service center 150 and/or another subscriber device 110₂ (e.g., desktop computer) that is coupled to network 100 over a wired interconnect 140.

As shown in FIG. 1, subscriber device 110₁ is in communication with backend service center 150, which includes a collection of one or more databases and/or network servers. After completing registration for a subscription service, such as any service featuring Terminal Services for example, backend service center 150 assists in the activation of applications (not shown) associated with the subscribed service. According to one embodiment of the invention, these applications include a remote communication module (not shown) that is configured to assist in performing wake-up operations on subscriber device 110₁, establishing network connectivity and ensuring that the network address (e.g., Internet Protocol “IP” address) assigned to subscriber device 110₁ is routable and available to the subscriber.

More specifically, as an illustrative example, subscriber device 110₁ features a transceiver that remains powered to receive messages even when subscriber device 110₁ is placed in a Shutdown (S5) state. Where transceiver is a wireless transceiver, it is powered so that it can receive a wireless message operating as a Wake-Up message. Upon receipt of the Wake-up message, subscriber device 110₁ is placed into an operation state (S0), and thereafter, the remote communication module (not shown) is responsible for temporarily controlling the operations of subscriber device 110₁ by establishing a network connection to backend service center 150, and sending a query message to inquire as to the reasons behind the Wake-up message.

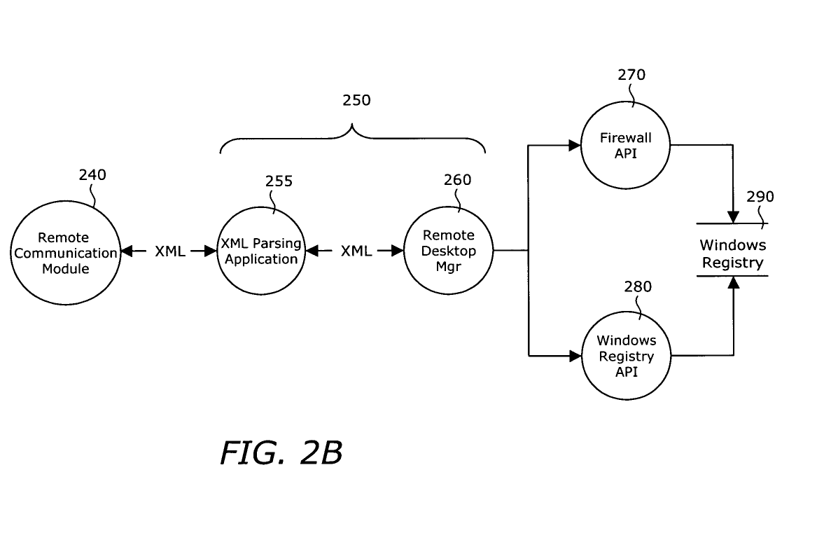

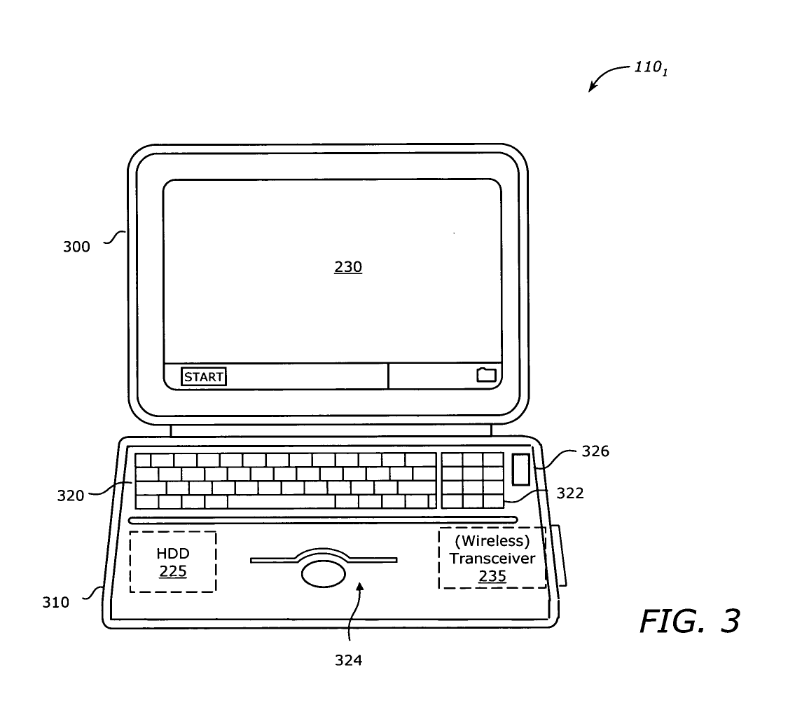

Referring now to FIG. 2A, an exemplary embodiment of the internal architecture of subscriber device 110₁ is shown. As described below, subscriber device 110₁ is implemented with a remote communication module 240 that enables control of subscriber device 110₁ remotely after waking up subscriber device 110₁ from any power-saving state including Shutdown (S5) state.

According to one embodiment of the invention, subscriber device 110₁ comprises a processor 200 coupled to a chipset 205. Chipset 205 controls the flow of information between processor 200, a main memory 210 and a plurality of input/output (I/O) devices 215 each coupled to an internal bus 220. According to one embodiment of the invention, the plurality of I/O devices 215 include, but are not limited or restricted to a hard disk drive (HDD) 225, a display 230, and a transceiver 235.

As shown, hard disk drive 225 is configured to include remote communication module 240, which is a series of instructions that run as a daemon process, such as hard-coded instructions that run as a Windows® Service, and thus, run before any login sessions are active to guarantee that its services are available whenever subscriber device 110₁ is operational. According to one embodiment of the invention, remote communication module 240 is preloaded on hard disk drive 225, although it could be loaded onto hard disk drive 225 from a separate source (e.g., downloaded from backend service center 150 of FIG. 1 or uploaded from a portable storage device such as a compact disc “CD”, digital versatile disk “DVD”, flash drive, flash memory, or the like).

Referring still to FIG. 2A, according to one embodiment of the invention, remote communication module 240 includes a set of services that are used by one or more applications 250. As an illustrative example, application(s) 250 may constitute a plug-in application that provides a particular service to the subscriber such as the ability to enable or provide remote Terminal Services.

It is contemplated that, in lieu of and in addition to being stored within hard disk drive 225, remote communication module 240 may be implemented within a different type of storage device or within transceiver 235.

Referring now to FIG. 2B, an illustrative embodiment of remote communication module 240 is shown. According to one embodiment of the invention, remote communication module 240 is software that uses an Extensible Markup Language (XML)-based Web Services interface provided by the NET framework. The Web Service interface deployed on a web server of the backend service center 150 of FIG. 1 is adapted to analyze an IP address associated with the query message generated by subscriber device 110₁ in response to the Wake-Up message and to report that IP address to the subscriber if subscriber device 110₁ is assigned a routable network address, namely an IP address that is uniquely assigned to the device (i.e., not a private IP address).

In the event that the supplied IP address is not a routable IP address, remote communication module 240 is instructed to re-attempt to establish network connectivity over the Internet using a different route or network interface. Such attempts may commence with initial attempts to establish a connection over a wired interconnect. If such attempts are unsuccessful, remote communication module 240 attempts to establish a wireless network connection using transceiver 235 of FIG. 2A. According to one embodiment of the invention, the wireless network connection involves cellular-based communications (e.g., any packet-based digital transmission inclusive of cellular transmissions based on the Global System for Mobile Communications “GSM” standard like 3G or 4G that normally assign routable IP addresses).

The new IP address is then reported to backend service center 150 of FIG. 1, which again evaluates the supplied IP address to determine if it is routable. This routable IP address evaluation can be performed using a variety of techniques. For instance, the IP address may be determined to be routable by comparing the reported IP address to the source IP address of one or more data packets transmitted from subscriber device 110₁ to backend service center 150. As another example, the routable IP address evaluation can also be performed by comparing the reported IP address to a known list of private IP addresses, such as 192.168.0.0/16, 10.0.0.0/8, or the like.

As shown, remote communication module 240 is in communication with an application 255, operating an XML parsing application for example, that can accept Terminal Services instructions. According to one embodiment of the invention, XML messages received by remote communication module 240 and XML parsing application 255 may be parsed where instructions (commands) involving Terminal Services are routed to a remote desktop manager 260, which controls Terminal Services and firewall settings to allow remote desktop communications with another electronic device.

As an example, upon receiving a message with instructions to enable Terminal Services (hereinafter referred to as a Remote_Terminal_Services_Enable “RTSE” message), remote communication module 240 launches XML parsing application 255 and then routes the RTSE message to XML parsing application 255, which is parsed and commands (instructions) subsequently routed to remote desktop manager 260. Thereafter, the collective application(s) 250 will notify remote communication module 240 when actions associated with the RTSE message have been completed. For this example, notification may occur after Windows® Firewall Application Programming Interface (API) 270 has been accessed to allow Terminal Services communications through the firewall and after Windows® Registry API 280 has been accessed to activate Terminal Services. Both results in particular settings within the Windows® Registry 290 of subscriber device 110₁.

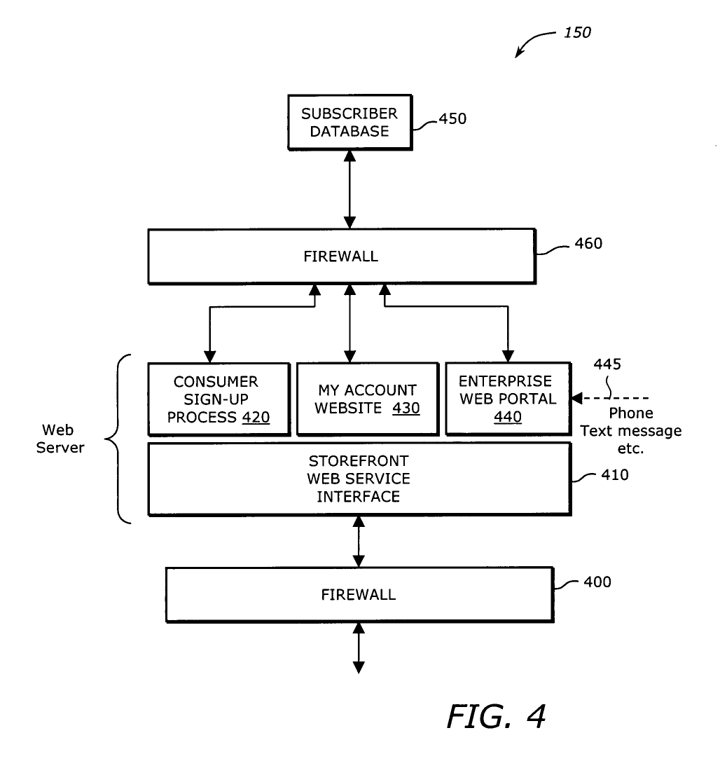

Referring now to FIG. 3, an exemplary embodiment of a block diagram of the external architecture of subscriber device 110₁ of FIG. 1 is shown. Subscriber device 110₁ includes a display 300 and a main body 310. Display 300 is a casing surrounding a flat panel display 230 such as a liquid crystal display, for example.

As further shown, main body 310 operates as a housing for components 200, 205, 210, 225 and 235 shown in FIG. 2A in order to protect these components from adverse environmental conditions that may damage these components. However, one or more input devices are positioned along an exterior surface of main body 310 and are accessible to the user. The input device(s) includes one or more of the following: a keyboard 320, a keypad 322, a touchpad 324, a biometric authentication device 326 or the like.

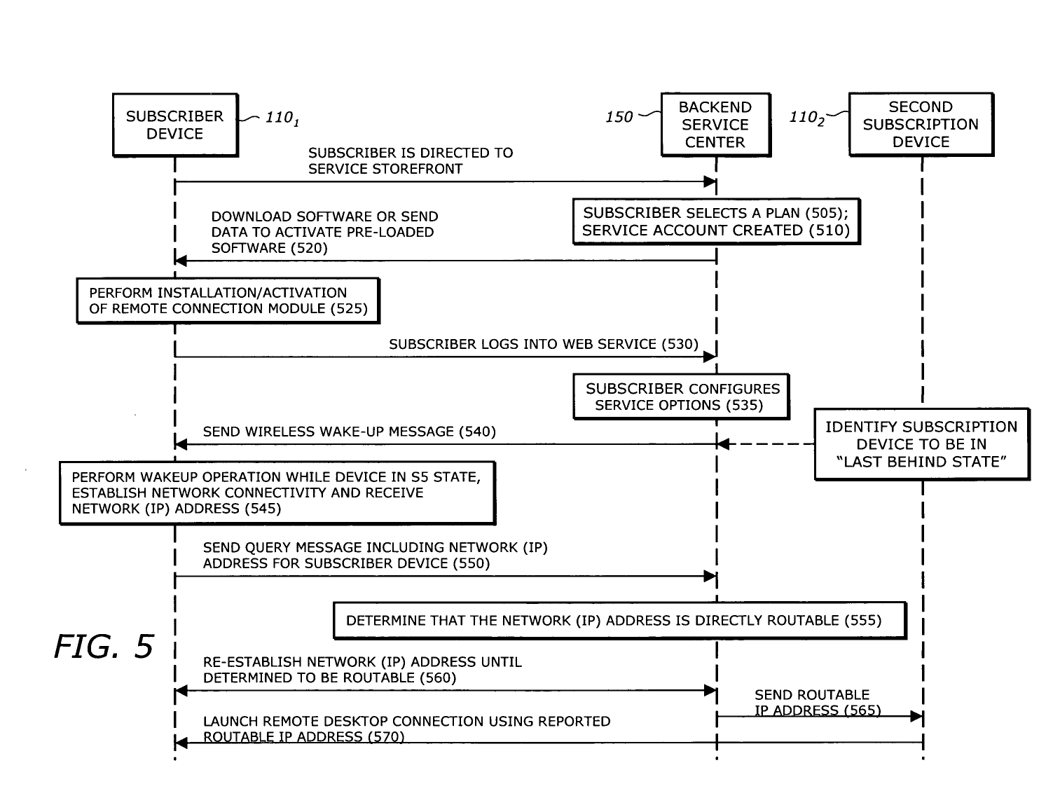

Referring now to FIG. 4, an illustrative embodiment of certain components forming backend service center 150 is shown. Backend service center 150 is adapted to allow users access a storefront web service interface 410 via a firewall 400 over a secure link (e.g., HTTPS connection). The storefront web service interface 410 provides the marketing verbiage that communicates the nature of the subscription services. Storefront web service interface 410 further includes individual or customer sign-up processes 420, “My Account” website 430 and an enterprise web portal 440.

Consumer sign-up process 420 is a process that allows consumers to create a service account for any available services such as device security, real-time news reporting and the like. For illustrative purposes, the device security services shall be discussed.

My Account website 430 allows each subscriber to sign in, manage his/her account and submit instructions processed by remote communication module 240 of the subscriber device. With respect to device security, for example, My Account website 430 presents a listing of scenarios that identify the current status of each subscriber device registered by the subscriber. As described below, the listing may include a primary scenario identifying that a particular subscriber device is secure and secondary scenarios where the subscriber has lost physical control of his or her device: “Stolen,” “Lost,” or “Left Behind” (misplaced). In response to selection of any of these secondary scenarios and inclusion of an action involving Terminal Services (e.g., Remote_Terminal_Services_Enable), signaling received by remote communication module 240 of FIG. 2A, interpreted to involve Terminal Services, will be routed to application(s) 250.

Enterprise web portal 440 provides access for enterprise administrators to add/remove subscribers and to activate or deactivate the subscriber device from its current state. Each enterprise administrator will automatically receive emails with his or her account information and uniform resource locator (URL) to the enterprise web portal 440. Enterprise web portal 440 then gives these administrators full control of the security services for their users. Of course, it is contemplated that the enterprise administrator may be informed of status changes by communications 445 other than by email (e.g., phone, in-person dialogue, text message, etc.). These alternative forms of communication prompt an administrator to act accordingly and modify the status of subscriber device 110₁.

Herein, the consumer sign-up process 420, My Account website 430 and enterprise web portal 440, are in communication with a subscriber database 450 via a firewall 460. Firewall 460 provides a secure communication path between the processes associated with storefront web service interface 410 and data stored in the subscriber database 450. The data stored within subscriber database 450 may be device-specific instructions corresponding to those actions selected for each scenario. Of course, if the instructions for each scenario are static and are not configurable by the subscriber, subscriber database 450 may store a common series of instructions for each scenario.

when the instructions are selectable by the subscriber. However, if the instructions are static for each scenario and are not configurable by the subscriber, subscriber database 450 would merely need to store a common series of instructions for each scenario (not subscriber dependent). Besides subscriber database 450, it is possible that such instructions may be stored in Web Service Interface 410 or even in the hard disk drive of the subscriber device.

### II. Exemplary Architecture of the Subscription Process

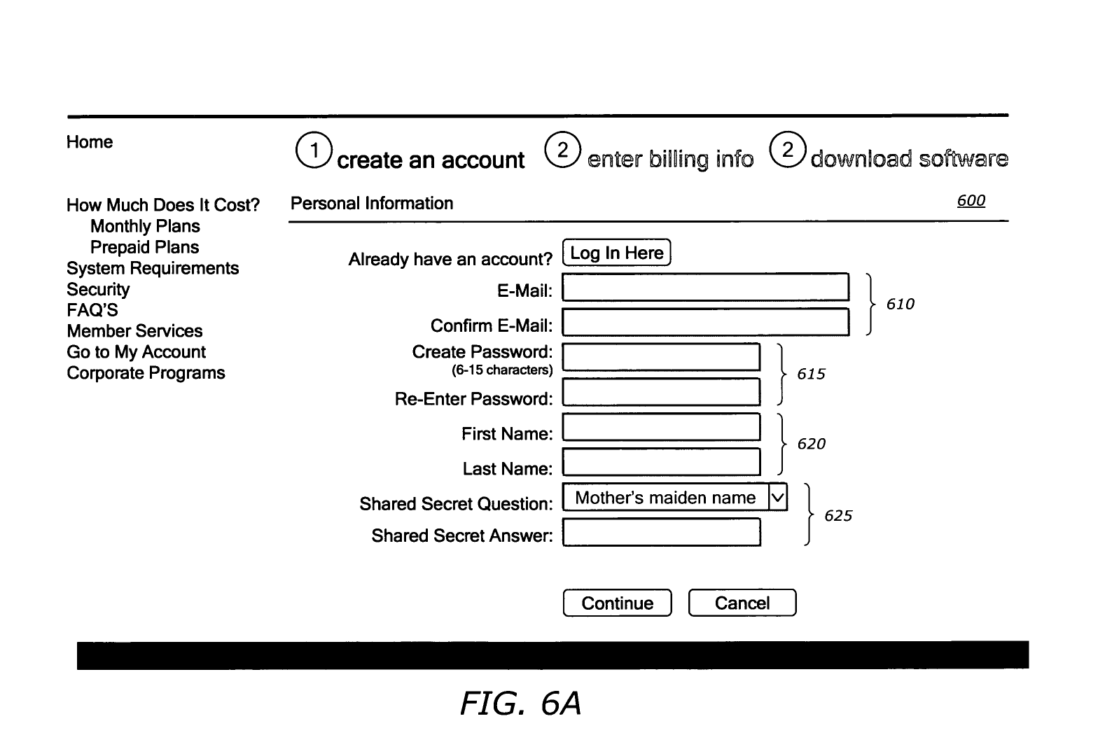

Referring now to FIG. 5, an illustrative embodiment of an exemplary embodiment of the subscription service from registration to detection of an event necessitating network connectivity by the subscriber device is shown. Initially, subscriber device 110₁ initiates communications to backend service center 150 as represented by operation 500. Such communications may be established by a subscriber accessing the storefront web service interface described above.

Upon establishing communications with backend service center 150, the subscriber selects a subscription plan including a desired service such as device security for example (operation 505). “Device security” is a service that causes the installation or activation of one or more security-based applications within subscriber device 110₁. According to this embodiment of the invention, the security-based application(s) perform activities to disable and/or enable Terminal Services. The performance of this activity may be initiated through real-time messaging from backend service center 150 as described below.

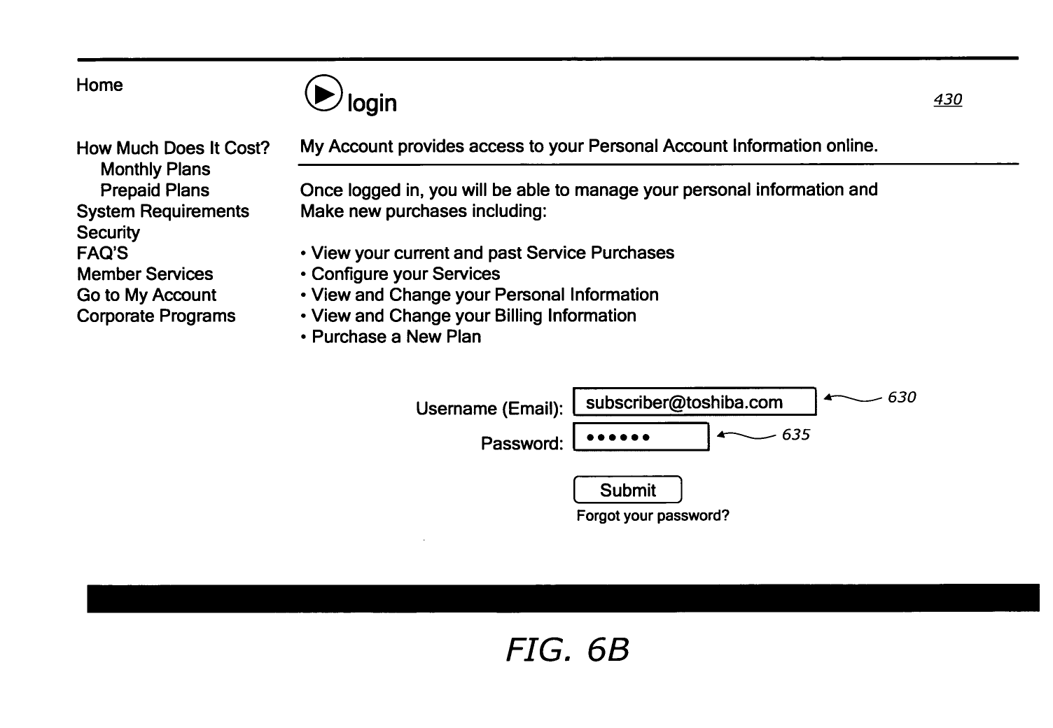

Before or after selecting the subscription plan, a service account is created in which a username and password are established for the subscriber (operation 510). As shown in FIG. 6A, according to one embodiment of the invention, the service account may be created based on information input into a subscription enrollment window 600.

For instance, as an illustrative example, the information input by the subscriber may include an electronic mail (email) address 610, a password 615 selected for accessing the service account, the first and last name of the subscriber 620, and a shared secret question and answer 625 for subscriber authentication and password resetting if the subscriber forgets his or her password.

After the service account is established, backend service center 150 downloads software, such as a set-up program, to subscriber device 110₁ for installation of the remote communication module and the applications supporting Terminal Services (operation 520). Of course, it is contemplated that software may not be downloaded, but rather, a message may be transmitted to subscriber device 110₁ in order to activate pre-loaded application(s) associated with Terminal Services.

Thereafter, installation and activation operations are performed (operations 525). According to one embodiment of the invention, this is accomplished by subscriber device 110₁ running an activation wizard. This wizard will prompt for the subscriber's current username and password, and thereafter, will securely send this information to subscriber database 450 of FIG. 4 along with optional information (e.g., ESN, phone number, computer name, model name, serial number, etc.) for identifying subscriber device 110₁ to the subscriber and to the security subnet. In response to subscriber database 450 receiving this information, a Globally Unique Identifier (GUID) will be sent to subscriber device 110₁ to be used in future communications with subscriber device 110 to security subnet 120. The wizard can be pre-installed on all subscriber devices to help advertise subscription services.

After installation and in order to configure service options, the subscriber logs into the “My Account” website 430 as shown in FIG. 6B (operation 530). The subscriber login may be accomplished by providing his or her username 630, such as the subscriber's email address, and a password 635 that was selected during creation of the service account as described in FIG. 6A.

After logging into the storefront web service interface, the subscriber may configure options for the service account (operation 535). According to one embodiment of the invention, as shown in FIG. 6C, the configuration would involve selection of a “Configure” element 640 that corresponds to various scenarios where the subscriber requests certain actions to be performed on the subscriber device via remote signaling.

In particular, upon selecting “Configure” element 640, a “Left Behind” programming page 650 is displayed as shown in FIG. 6D. Programming page 650 allows one or more actions to be selected that, upon requesting placement of the subscriber device into the “Left Behind” state, the backend service center transmits instructions associated with the actions to subscriber device 110₁ in order to enable Terminal Services such as a Remote Desktop Connection.

More specifically, upon selection of the “Add Action” button 655, a complete list of actions is provided in a pop-up window 660. Pop-up window 660 includes a list of all possible actions that can performed by the subscriber device when identified as being “left behind”. Selection of the instruction to enable Terminal Services, namely a Remote Desktop Connection, is performed through use of an “Add Action” button 655 (see FIG. 6D).

Upon the subscriber selecting the “Enable Remote Terminal Connection” action, pop-up window 660 disappears and the selected action are now listed in an instruction window 670. Instruction window 670 identifies the action or actions that will be performed based on instructions that will be transmitted upon completion of programming page 650 or when the subscriber wishes to place the subscriber device into the “Left Behind” state remotely. These actions can be reviewed by use of scroll buttons 675 to move a selected action in instruction window 670 to precede or follow another action.

In order to delete actions listed in instruction window 670, the action is first selected and then a “Delete Action” button 680 is selected. This will remove the selected action from instruction window 670. Upon completion, a “Done” button 690 may be selected to exit programming page 650.

Referring back to FIG. 5, subscriber device 110₁ receives a wireless message from backend service center 150 to signal to subscriber device 110₁ to wake-up from any power-saving (S3-S5) state and establish network connectivity (operations 540 and 545). This wireless message may be initiated by the subscriber logging into backend service center 150 and setting the status of subscriber device 110₁ as “Left Behind”. Thereafter, a query message is transmitted to backend service center 150. The query message includes the network (IP) address of the subscriber device 110₁ (operation 550).

Upon receipt of the query message, backend service center 150 determines if the network (IP) address is routable, and if not, returns a message to subscriber device 110₁ to re-establish network connectivity until a routable network (IP) address is obtained (operations 555 and 560). Backend service center 150 also sends a Remote_Terminal_Services_Enable (RTSE) message to activate Terminal Services within subscriber device 110 as well as make any necessary firewall adjustments to support Terminal Services. This RTSE message may be sent with the wireless message to re-establish network connectivity until a routable network (IP) address is obtained (operations 555 and 560). Alternatively, the RTSE message may be sent separately upon obtaining a routable network (IP) address for subscriber device 110₁.

Once Terminal Services are enabled and available on subscriber device 110₁ and the routable network (IP) address has been reported to the subscriber (from another subscriber device 110₂) as set forth in operation 565, the subscriber (from another subscriber device 110₂) may initiate a Remote Desktop Connection to subscriber device 110₁ (e.g., launching the Remote Desktop Connection software, etc.).

### III. Exemplary Architecture of the Remote Communication Module

A. Messaging Services

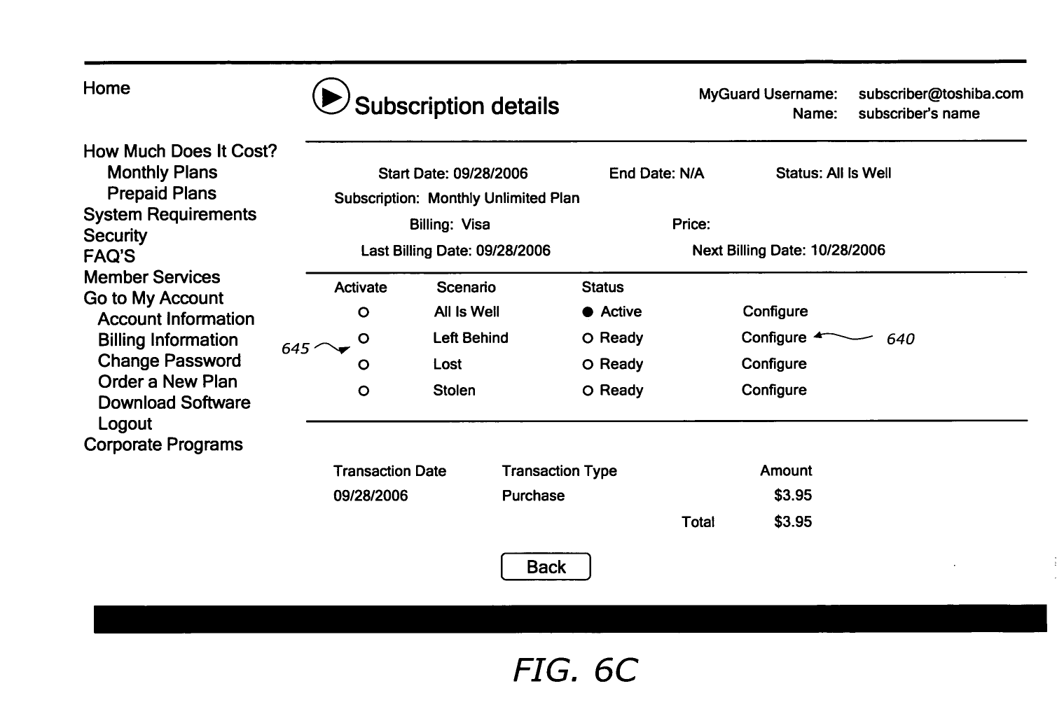

Referring now to FIG. 7, an illustrative embodiment of the block diagram describing the operations of remote communication module 240 is shown. Herein, with respect to messaging services, remote communication module 240 uses a Simple Object Access Protocol (SOAP) XML-based interface 700 to communicate over network 100. Interface 700 is configured to support the routing of a variety of message formats, including encapsulated XML messages, to subscriber device 110₁.

Upon receiving an encapsulated XML message 800, remote communication module 240 parses this message and places in a message queue 710. Optionally, message 800 may be time-stamped, encoded and saved persistently. Thereafter, upon detecting that XML message 800 contains data intended for XML parsing application 255, a portion of XML message 800 is passed to XML parsing application 255. Thereafter, XML parsing application 255 then parses the XML command, launches the appropriate client application (e.g., Remote Desktop Manager application 260) and sends the remainder of XML message 800 to that application. The remainder of XML message 800 includes instructions directed to enabling Terminal Services and setting the firewall to allow Terminal Services for this example. Thereafter, remote communication module 240 will be notified when the requested action has been completed (e.g., Terminal Services enables or disabled, firewall API set, etc.).

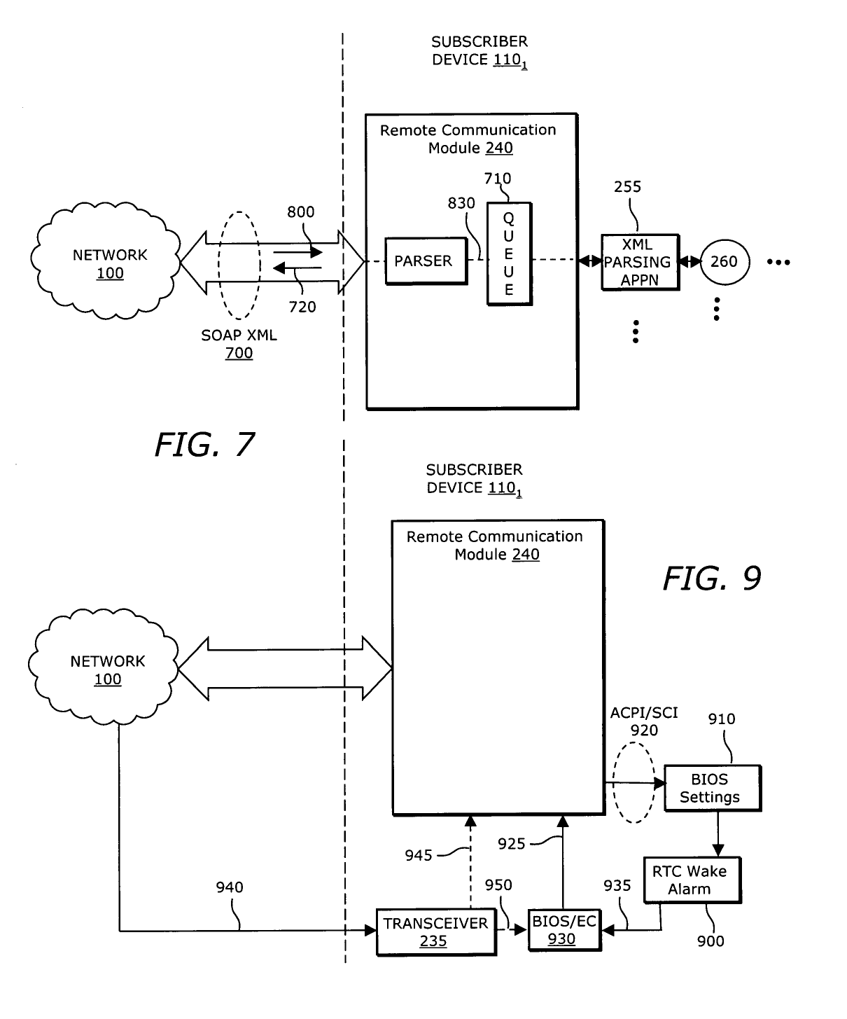

As illustrated in FIGS. 7 and 8, remote communication module 240 parses a portion of message 800 received over network 100, namely an encapsulated XML message, in order to determine the targeted destination for contents of encapsulated XML message 800. Hence, remote communication module 240 ignores one or more inner XML documents 830 directed to establishing a Remote Desktop connection within encapsulated XML message 800. Instead, the XML document(s) 830 is(are) provided to application(s) 250, which parse this information and cause the requested actions to be performed. An exemplary embodiment of encapsulated XML message 800 is shown in FIG. 8.

As illustrated, an out-most XML document 805 of encapsulated XML message 800 uses the SOAP format and operates as an interface between web services and remote communication module 240. Out-most XML document 805 includes polling parameters 810.

As further shown, a nested XML document 820 is encapsulated within outer-most XML document 805. Nested XML document 820 includes a plurality of inner XML documents 825 and 830 (starting with “<?xml . . . >”), each encased in CDATA tags, which are ignored by XML parsers. A first inner layer of nested XML document, namely a first inner XML document 825, is parsed by remote communication module 240, in order to determine how to route the next layer of the nested XML. The next layer of nested XML document, namely a second inner XML document 830, is ignored by remote communication module 240 and passed onto XML parsing application 255 for subsequent parsing and to enable Terminal Services.

Remote communication module 240 parses first inner XML document 825 and also starts XML parsing application 255. The name (MyGuard) and path (MyGuard.exe) is used to locate and start application 255 on subscriber device 110₁.

Lastly, second inner XML document 830 is ignored by remote communication module 240. Rather, second inner XML document 830 is passed to XML parsing application 255 after it is launched. Second inner XML document 830 is parsed by XML parsing application 255 and would be routed to the remote desktop manager (not shown) that is responsible for enabling or disabling Terminal Services. It is the CDATA XML type that is used to encapsulate the nested XML interface layers.

B. Network Services

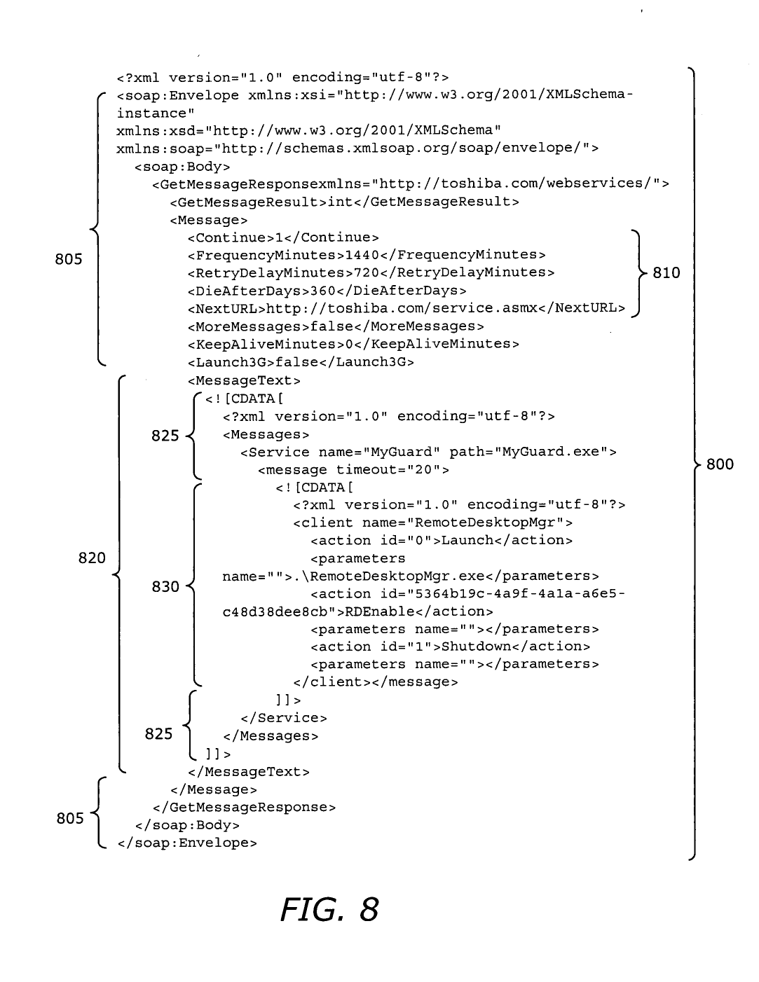

Referring now to FIG. 9, an exemplary embodiment illustrating the control wake-up operations by remote communication module 240 is shown. Remote communication module 240 supports network connectivity that is initiated by subscriber device 110₁ (e.g., polling events, messages from applications, etc.) and network connectivity based on signaling received from a remote source.

With respect to polling operations, remote communication module 240 manages the polling interval and scheduling by setting RTC Wake Alarm 900 via BIOS setting 910 (over ACPI or SCI interface 920) to commence wake-up of subscriber device from S3, S4 or S5 states. According to one embodiment, this may be accomplished by signaling 925 from a component 930 (e.g., BIOS or embedded controller “EC”) in response to an RTC Wake event 935. The polling interval and scheduling may be modified by the subscriber or by the Web Service through transmission of modified polling parameters 810 as illustrated in FIG. 8.

When it is time to poll or perform a particular task requiring network connectivity, remote communication module 240 determines whether network connectivity is present. If not, remote communication module 240 will automatically attempt to establish network connectivity. For instance, remote communication module 240 may attempt to establish a network connection over a wired interconnect if subscriber device 110₁ features a wired transceiver. If such attempts are unsuccessful, however, remote communication module 240 automatically establishes a wireless (e.g., 3G or 4G) network connection by activating the wireless transceiver (e.g., activating a 3G or 4G-cellular transceiver implemented within the subscriber device). In one embodiment of the invention, remote communication module 240 will iterate over a number of potential network connectivity options in its attempt to establish network connectivity. Potential network connectivity options may include Ethernet, phone line modems, WiFi, Bluetooth®, 3G, 4G, or any other means that allows remote communication module 240 to establish connectivity with network 100.

Besides polling and scheduling, remote communication module 240 is adapted to establish network connectivity based on signaling 940 from a remote source over a wired medium (e.g., “Wake On LAN” signaling, phone call over landline, etc.) or signaling 940 over a wireless medium (e.g., radio frequency signal, cellular signal, wireless text message, etc.). Remote communication module 240 is operational while subscriber device 110₁ is in S0 state, and therefore, is notified to established network connectivity by transceiver 235 via signaling 945. However, when subscriber device 110₁ is in a power-saving state (S3-S5), remote communication module 240 is inoperable and is activated by component 930 after its receipt of a Wake command 950 from transceiver 235. This requires transceiver 235 to be powered during all power-saving states.

Thereafter, remote communication module 240 will establish network connectivity with the backend service center. This will enable the subscriber device to receive instructions that perform certain actions such as one or more of the security-based action illustrated in FIG. 6D.

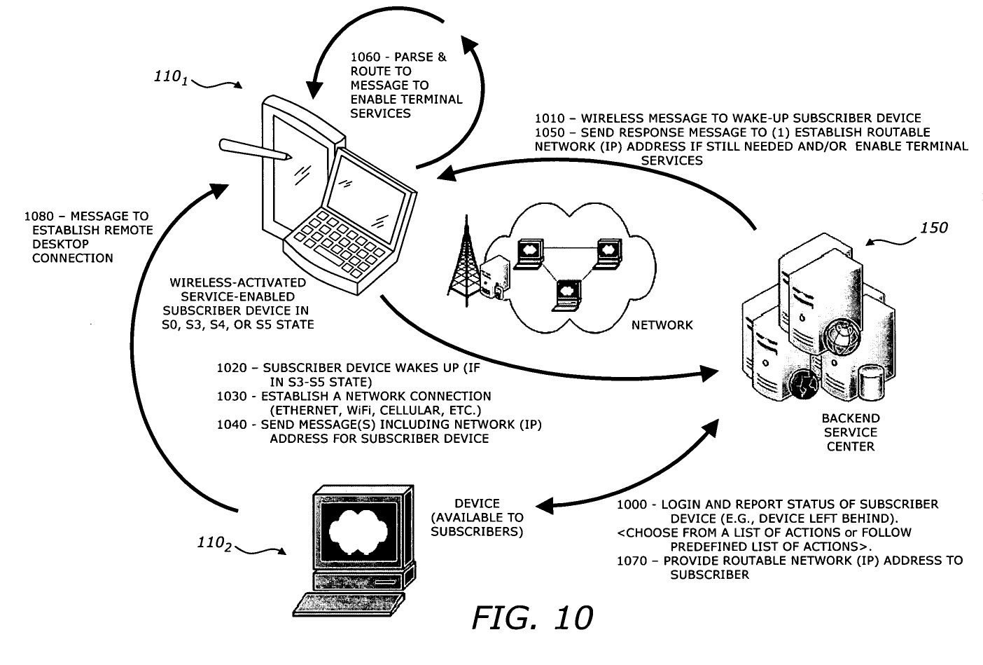

Referring now to FIG. 10, an illustrative embodiment of the operations of subscriber device 110₁ and backend service center 150 is shown. Subscriber device 110₁ is in a powered state (S0) or a power-saving (S3, S4 S5) state, and the subscriber has discovered that this device has been left at another location.

As shown, the subscriber establishes a network connection to backend service center 150 using another subscriber device 110₂ and, since subscriber device 110₁ has been left at another location, the subscriber sets the status of subscriber device 110₁ to “Left Behind” (operation 1000). In response to this status setting operation, backend service center 150 transmits a wireless message to subscriber device 110₁ in the event that subscriber device 110₁ is in a power-saving (S3-S5) state (operation 1010). As an optional feature, although not shown, a message with instructions corresponding to the actions requested by the subscriber may be sent concurrently in case subscriber device 110₁ is operational (S0 state).

Upon detecting the wireless message and residing in a power-saving state, subscriber device 110₁ wakes up from its power-saving state (e.g., S3-S5 state), establishes network connectivity and connects to backend service center 150 (operations 1020 and 1030). Moreover, a query message is sent to backend service center 150. The query message includes the network (IP) address in its communication with backend service center 150.

Thereafter, backend service center 150 compares the network (IP) address that was sent from subscriber device 110₁ with the network (IP) address that is reported by backend service center 150 as the IP address associated with the query message (operation 1040). If the two network (IP) addresses do not match, then it is determined that subscriber device 110₁ is within a subnet and that it cannot be reached remotely using either IP address via a Remote Desktop client application.

This routable IP address evaluation can be done using a variety of techniques. For instance, the IP address may be determined to be “routable” by comparing the reported IP address to the source IP address of the data packet. As another example, the routable IP address evaluation can also be performed by comparing the reported IP address to a known list of private IP addresses, such as 192.168.0.0/16, 10.0.0.0/8, etc.

Hence, if a routable IP address has not been received, backend service center 150 returns an XML response that includes a request to establish an alternate connection so that subscriber device 110₁ can be reached, namely establish a connection with a routable network (IP) address (operation 1050). As an option, the XML response may also include a request to enable Terminal Services.

Upon receiving the XML response with a request to enable Terminal Services, the remote communication module of subscriber device 110₁ launches the XML Parsing application supporting Terminal Services, if it is not already running, and forwards the XML command onto the XML Parsing application. When the application receives this command, it launches the RemoteDesktopMgr application and forwards the XML command onto RemoteDesktopMgr. RemoteDesktopMgr parses the XML command and determines what action to take (enable or disable). In the case of enable, the Windows® Firewall API is used to place Terminal Services on the firewall exclusion list so that it will not be blocked. Then, the registry is modified to enable Terminal Services. In the case of disable, the registry is modified to disable Remote Desktop (Operation 1060).

After successfully completing such a network connection, reporting the new IP address to backend service center 150, and enabling Terminal Services (including opening necessary firewall holes), the subscriber now has access to the network (IP) address of subscriber device 110₁ (operation 1070). As a result, the subscriber can activate Remote Desktop Connection services on subscriber device 110₂ and access content on subscriber device 110₁ (operation 1080).

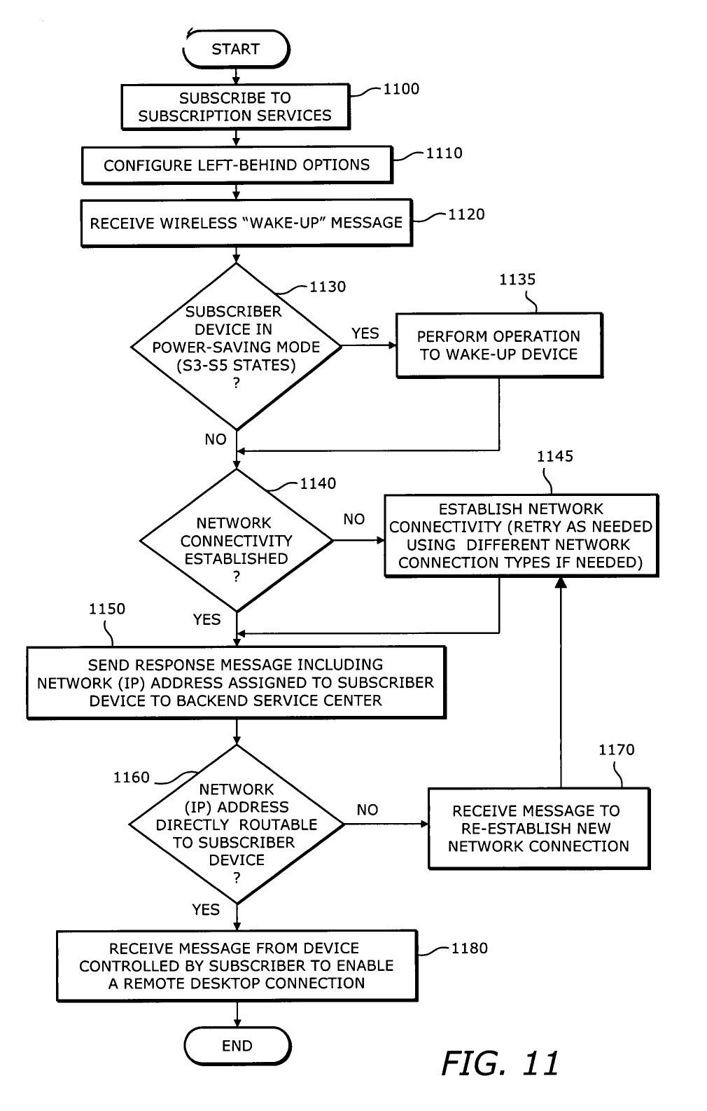

Referring to now FIG. 11, an illustrative embodiment of operations performed by subscriber device 110₁ to establish a Remote Desktop connection despite the subscriber device operating in any power-saving state (e.g., S5 state) is shown. Upon subscribing to subscription services (and configuring security options accordingly), the subscriber device receives a Wake-Up message such as a wireless message (operations 1100, 1110 and 1120).

Upon receipt of the Wake-Up message, if the subscriber device is in a power-saving (S3-S5) state, a wake-up operation is performed and a determination is made whether the subscriber device is presently connected to the network (operations 1130, 1135 and 1140). If not, the subscriber device establishes network connectivity through a wired or wireless interconnect and sends a query message including the network (IP) address assigned to the subscriber device during establishment of the network connection (operations 1145 and 1150).

If the network (IP) address is determined to be non-routable, the subscriber device receives a message to re-establish an alternative network connection (operations 1160 and 1170). Once the network (IP) address for an established network connection is determined to be routable, the network (IP) address can be used to enable Terminal Services and adjust firewall settings within the subscriber device, and thereafter, establish a Remote Desktop connection with the subscriber device (operation 1180).

As a result, this mechanism can remove a subscriber device from a power-saving state and enable Terminal Services as well as alter the firewall setting to allow Terminal Services as needed.

In the foregoing description, the invention is described with reference to specific exemplary embodiments thereof. It will, however, be evident that various modifications and changes may be made thereto without departing from the broader spirit and scope of the present invention. Therefore, the specification and drawings are accordingly to be regarded in an illustrative rather than in a restrictive sense.

What is claimed is:

1. A method comprising:
establishing network connectivity by an electronic device, the electronic device currently operating in a state that precludes access to the electronic device remotely; and
altering the state of the electronic device to allow access to the electronic device remotely.

2. The method of claim 1 wherein the electronic device being in the state with Terminal Services disabled.

3. The method of claim 2 wherein the electronic device being in the state having a firewall that precludes Terminal Services and thereby prevents access to the electronic device remotely.

4. The method of claim 1 wherein the electronic device being in the state having a firewall that precludes Terminal Services and thereby prevents access to the electronic device remotely.

5. The method of claim 1 wherein the establishing of network connectivity includes waking up the electronic device from a power-saving state and providing a routable Internet Protocol (IP) address to identify the electronic device.

6. The method of claim 5 wherein the state that precludes access to the electronic device remotely is a Shutdown (S5) state.

7. The method of claim 1 wherein the altering of the state of the electronic device includes (i) changing a setting of the electronic device to allow for remote access of stored data or remote control of the electronic device, and (ii) establishing network connectivity with the electronic device to remotely access the stored data or remotely control functionality of the electronic device.

8. The method of claim 1 wherein the electronic device being in the state when an Internet Protocol (IP) address of the electronic device is unavailable.

9. The method of claim 1 wherein the establishing of network connectivity comprises (i) sending a wireless message from the electronic device, the wireless message including a routable Internet Protocol (IP) address, and (ii) using the routable IP address of the electronic device to alter the state of the electronic device.

10. The method of claim 1 wherein prior to establishing the network connectivity, the method further comprises selecting an action to enable a remote terminal connection with the electronic device in response to an event including misplacement of the electronic device.

11. Software stored in machine-readable medium and executed by a processor of a subscriber device to establish connectivity with a remotely located electronic device, comprising:
a first software module to establish network connectivity with the electronic device when the subscriber device is currently in a state that precludes access to the subscriber device remotely; and
a second software module to alter the state of the subscriber device to allow access to the subscriber device remotely.

12. The software of claim 11 wherein the subscriber device implemented with the first software module and the second software module being in the state with Terminal Services disabled thereby preventing access to the subscriber device remotely.

13. The software of claim 11 wherein the subscriber device implemented with the first software module and the second software module being in the state having a firewall that precludes Terminal Services and thereby prevents access to the subscriber device remotely.

14. The software of claim 12 wherein the first software module to establish network connectivity by waking up the subscriber device from a power-saving state and providing a routable Internet Protocol (IP) address to the electronic device for subsequent receipt of a message to activate Terminal Services.

15. The software of claim 14 wherein the state that precludes access to the subscriber device remotely is a Shutdown (S5) state.

16. The software of claim 11 wherein the second software module to alter the state of the subscriber device by (i) waking up the subscriber device from a power-saving state, (ii) changing a setting of the subscriber device to allow for remote access of stored data or remote control of the subscriber device, and (iii) establishing network connectivity with the subscriber device to remotely access stored data or remotely control functionality of the subscriber device.

17. A subscriber device, comprising:
a processor;
a transceiver communicatively coupled to the processor;
a first module in communication with the transceiver to establish network connectivity even though the subscriber device is in a state that precludes access to the subscriber device remotely; and
a second module to alter the state of the subscriber device to allow access to the subscriber device remotely.

18. The subscriber device of claim 17 being in the state with Terminal Services disabled thereby preventing remote access.

19. The subscriber device of claim 17 wherein the first module and the second module are software modules stored in a memory accessible to the processor.

20. The subscriber device of claim 18 wherein the first module to establish network connectivity by waking up the subscriber device from a power-saving state and providing a routable Internet Protocol (IP) address to networked electronic device for subsequent receipt of a message to activate Terminal Services.

21. The subscriber device of claim 17 wherein the state that precludes access to the subscriber device remotely is a Shutdown (S5) state.
